(19) United States
(12) Patent Application Publication
(10) Pub. No.: US 2013/0181819 A1
(43) Pub. Date: Jul. 18, 2013

(54) PHYSICAL TAG-BASED SUBSCRIPTION SERVICES

(71) Applicant: Dave MCLAREN, Los Altos, CA (US)

(72) Inventor: Dave MCLAREN, Los Altos, CA (US)

(73) Assignee: CISCO TECHNOLOGY, INC., San Jose, CA (US)

(21) Appl. No.: 13/350,656

(22) Filed: Jan. 13, 2012

(51) Int. Cl. H04Q 5/22; H04B 5/00

(52) U.S. Cl. 340/10.4

(57) ABSTRACT

Methods and apparatus are provided for automatically subscribing to a web-based service or resource based on reading a physical tag (e.g., an RFID tag) placed within range of a network device (e.g., a home network router) in a smart home network. The tag may store basic information about the web-based service or resource. When the tag is read, the network device may automatically contact the service or resource provider in an effort to subscribe a user to that service or resource, such that the service or resource may be enabled at that network device. In this manner, the user may quickly and easily subscribe to web-based services and/or resources, without having to configure anything, select any menu choices, type in any information, etc.

### TECHNICAL FIELD

Embodiments of the present disclosure generally relate to network communications and, more particularly, to using a physical tag to automatically subscribe to a service or resource.

### BACKGROUND

A home network enables Internet connectivity and data sharing among computing devices within a home that are connected to that network. Because of this Internet connectivity, a user of a home network may access his or her home network and any devices thereon remotely (e.g., from a workstation at the user's office or from another home network). For example, a user may be able to remotely turn on/off lights, control appliances, adjust a programmable thermostat, manage a sprinkler system, or activate a security system at his or her home.

To allow computing devices to be placed remotely from one another and/or from a home network router, many home networks are fully or partially wirelessly connected. Wireless home networks typically include a wireless router (i.e., the home network router) that is hard wired to a modem. The modem, which is often provided by a telephone or cable company, is connected to an external network, such as the Internet, and allows information to flow between the external network and the home network. Each computing device in the home network is connected to the wireless router through a wireless network adapter that is either internal or external to the computing device.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A is an exemplary illustration of an overarching network system configured to implement one or more aspects of the present disclosure.

FIG. 1B illustrates the smart home network of FIG. 1A, according to one example embodiment of the present disclosure;

FIG. 1C illustrates the smart home network of FIG. 1A, according to another example embodiment of the present disclosure;

FIG. 1D illustrates the smart home network of FIG. 1A, according to yet another example embodiment of the present disclosure;

FIG. 1E is a more detailed illustration of the smart network host device of FIG. 1A, according to one example embodiment of the present disclosure;

FIG. 1F illustrates a system software architecture for the smart network host device of FIG. 1E, according to one example embodiment of the present disclosure;

FIG. 2 illustrates the smart network host device of FIG. 1E, configured to read an electromagnetic tag, according to one example embodiment of the present disclosure.

FIG. 3 is a flow diagram of example operations for automatically subscribing to a web-based service or resource based on reading an electromagnetic tag, according to one example embodiment of the present disclosure.

### DESCRIPTION OF EXAMPLE EMBODIMENTS

### Overview

Embodiments of the present disclosure generally relate to methods and apparatus for using a physical tag to automatically subscribe a user in a smart network to web-based services or resources.

One embodiment of the present disclosure provides a method. The method generally includes reading an electromagnetic tag within range of a network device, wherein the tag has a predefined association with a web-based service or resource (accessible via the Internet), and automatically subscribing to the service or the resource based on the reading.

Another embodiment of the present disclosure provides an apparatus. The apparatus generally includes a reader and a processor. The reader is typically configured to read an electromagnetic tag within range of the reader, wherein the tag has a predefined association with a web-based service or resource. The processor is generally configured to automatically subscribe to the service or the resource based on the reading of the tag.

Yet another embodiment of the present disclosure provides an apparatus. The apparatus generally includes means for reading an electromagnetic tag within range of a network device, wherein the tag has a predefined association with a web-based service or resource; and means for automatically subscribing to the service or the resource based on the reading.

Yet another embodiment of the present disclosure provides an apparatus. The apparatus generally includes a housing, a storage medium, and an antenna. The storage medium is typically disposed within the housing and configured to store an indication of a predefined association with a web-based service or resource accessible via the Internet to be automatically subscribed to by a smart host network device. The antenna is typically configured to transmit the indication of the predefined association with the service or the resource.

Yet another embodiment of the present disclosure provides a method. The method generally includes receiving, at a smart network host device, a signal from a radio frequency identification (RFID) tag (e.g., after the RFID tag is placed within range of the smart network host device), wherein the signal indicates an RFID number associated with a web-based service or resource; and automatically subscribing to the service or the resource indicated by the received signal by transmitting a message from the smart network host device to a service or resource provider for activation of the service or the resource for the smart network host device.

### Example Embodiments

Embodiments of the present disclosure provide methods and apparatus for automatically subscribing to and enabling a web-based service or resource based on reading a tag (e.g., an RFID tag) at a network device (e.g., a home network router). To read the tag, the tag may be swiped or placed in close proximity to the network device. The tag may store basic information about a web-based service or resource. When the tag is read, the network device may contact the web-based service or resource provider and automatically subscribe the user to that service or resource, such that the service or resource is enabled (e.g., accessed or added) at the network device. In this manner, a user may quickly and easily subscribe to web-based services or resources, without having to configure anything, select any menu choices, type in any information, etc.

### An Example Smart Home Network

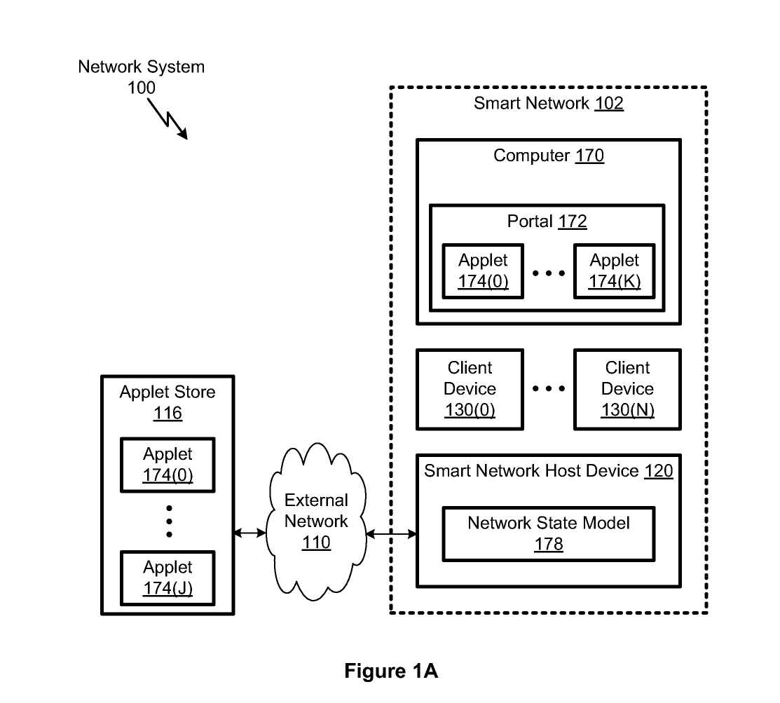

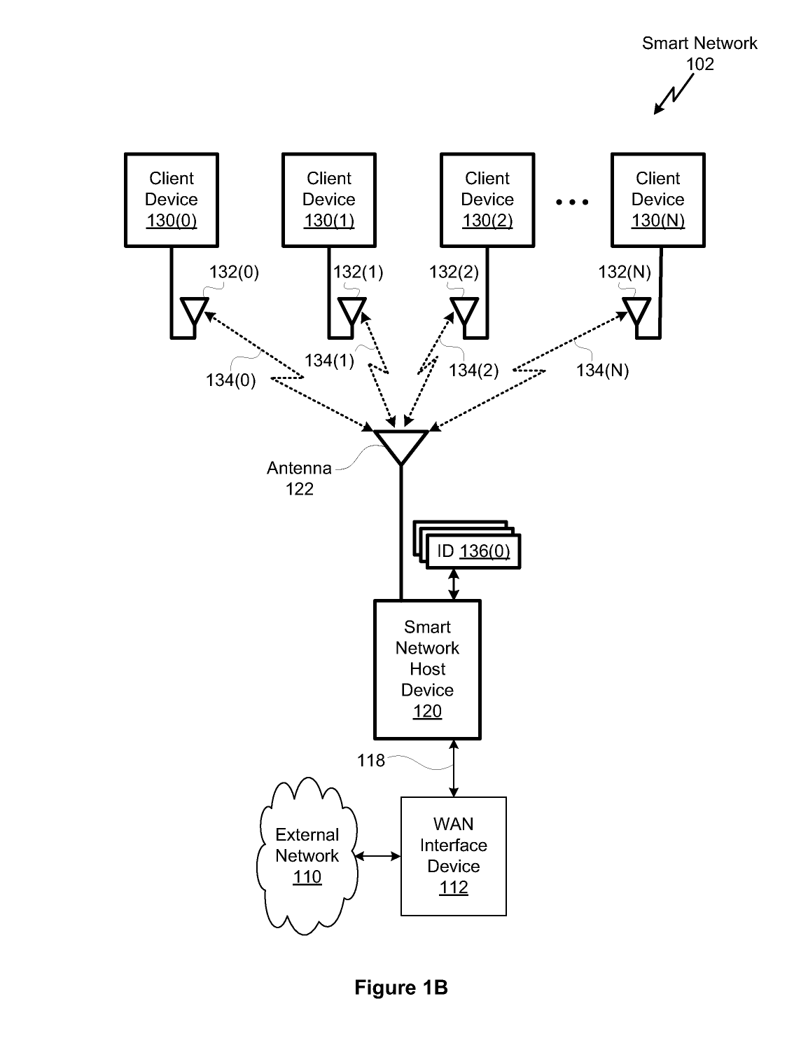

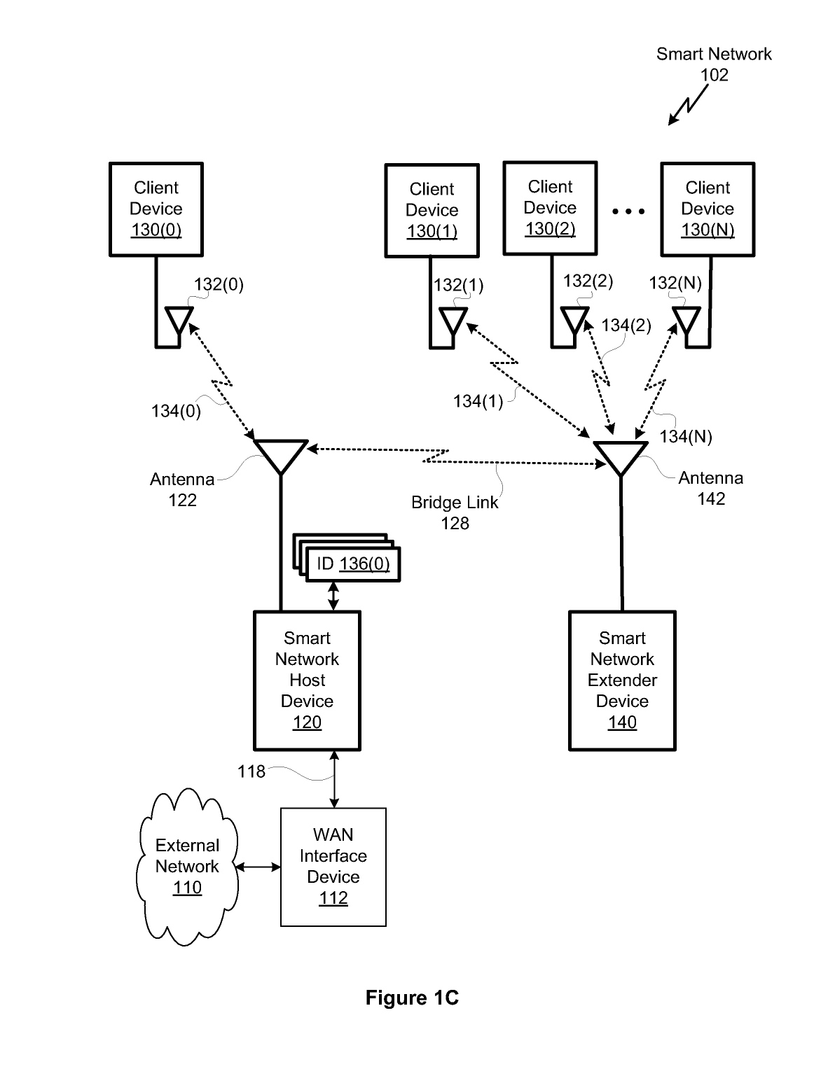

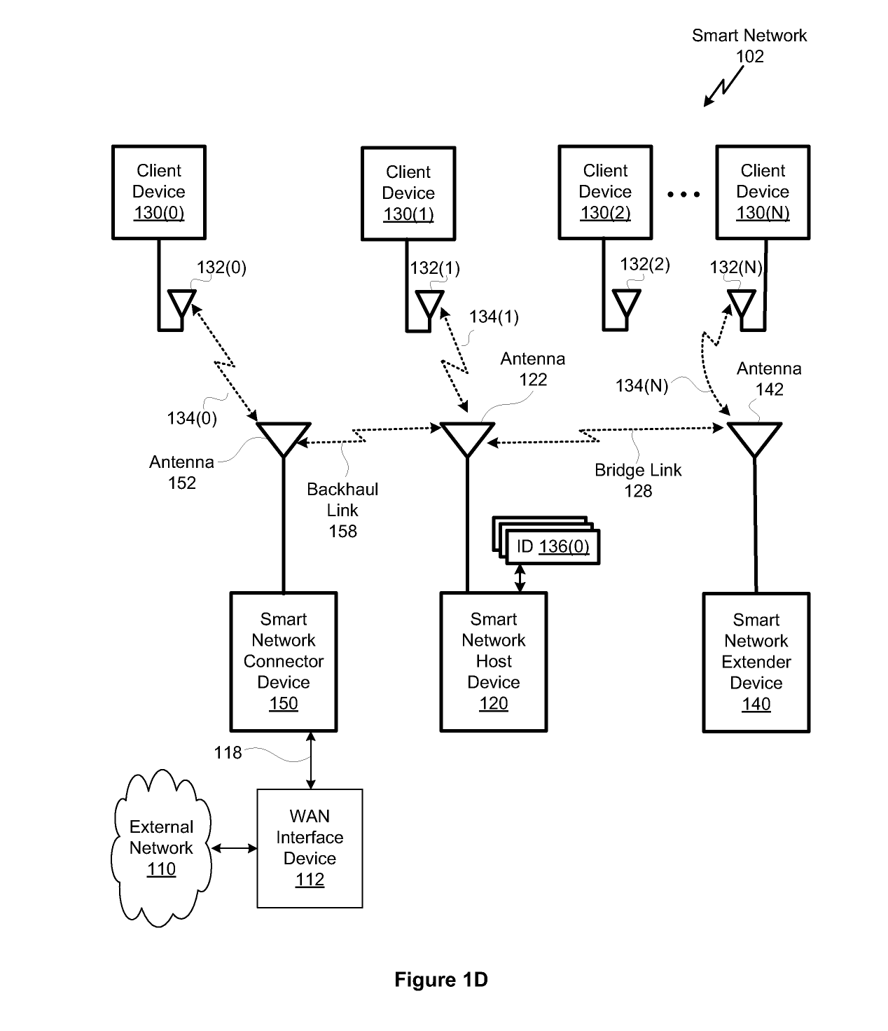

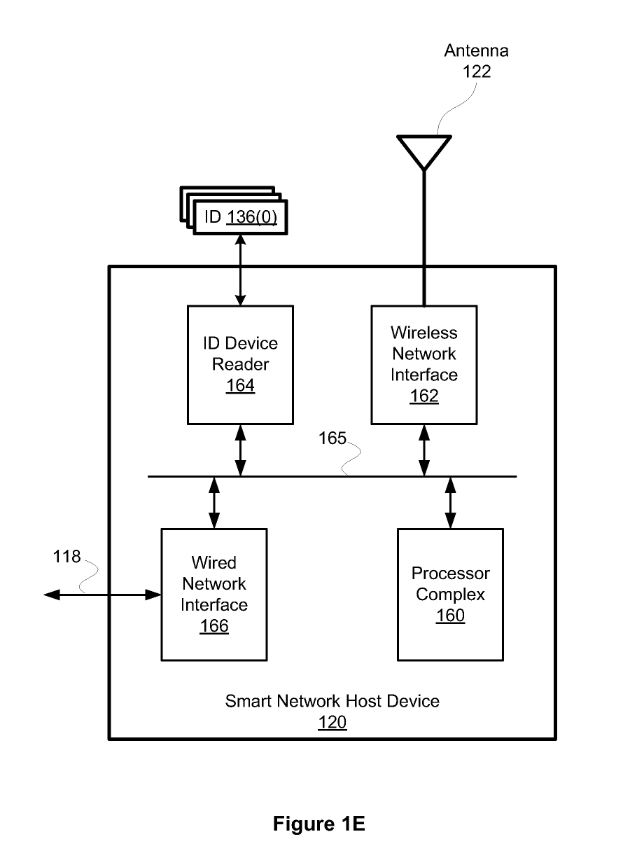

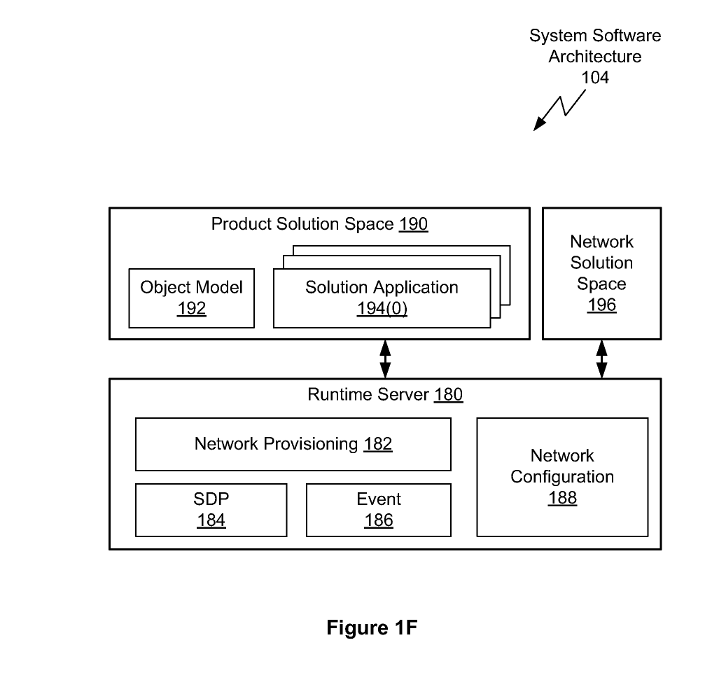

FIG. 1A illustrates a network system 100, configured to implement one or more aspects of the present disclosure. The network system 100 comprises a smart network 102, an external network 110, and an applet store 116. The external network 110 may comprise the well-known Internet or any other data network system. The smart network 102 includes a smart network host device 120 configured to transmit network data packets between the external network 110 and connected devices within the smart network 102, such as computer 170 and client devices 130. Any technically feasible wireless or wired physical transport technology may be implemented to transmit the network data packets. The smart network host device 120 maintains a network state model 178 that represents the different entities and related services operating within the smart network 102. For example, if client device 130(0) implements a printer with an integrated scanner and flash memory reader, then the network state model 178 would include an entry for client device 130(0), and related attributes for a printer service, scanner service, and file (or block device) service. New devices register with the smart network host device 120, which then updates the network state model 178 to include the new device.

A portal application 172, residing within the computer 170, is configured to access the network state model 178 to determine which client devices 130 are available within the smart network 102, which services the client devices 130 provide, and to access and use the services. The portal application 172 may include one or more applets 174, configured to extend functionality of the portal application 172. A given applet 174 may be associated with a specific client device 130 and may facilitate specific usage models for the client device 130 via the extended functionality. When a new client device 130 registers with the smart network 102, a most recent version of a corresponding applet 174 may not be available within the portal application 172. However, the portal application 172 may retrieve the corresponding applet 174 or version of the corresponding applet 174 from the applet store 116.

The applet store 116 is configured to facilitate access to applets 174 by the portal application 172. The applet store 116 provides storage for applets 174 corresponding to client devices 130 and makes the applets 174 available for download to the portal application 172 via the external network 110. In one embodiment, the applet store 116 occupies a well-known location, such as a universal resource locator (URL) associated with the external network 110. Any technically feasible technique may be used to identify a particular applet 174 as corresponding to a particular client device 130. Furthermore, any technically feasible technique may be used to download the particular applet 174 and incorporate the functionality of the applet 174 to the portal 172.

FIG. 1B illustrates the smart network 102, according to one embodiment of the present disclosure. As shown, the smart network 102 comprises a smart network host device 120, one or more client devices 130, and a wide area network (WAN) interface device 112, coupled to the external network 110 of FIG. 1A. The WAN interface device 112 may implement a cable modem, digital subscriber line (DSL) modem, fiber to the home interface, or any other technically feasible device that provides digital network connectivity to the external network 110. The WAN interface device 112 is coupled to the smart network host device 120 via a network interface 118. In one embodiment, the network interface 118 implements the well-known Ethernet standard.

The smart network host device 120 implements a wireless network interface coupled to antenna 122, which is configured to convert electrical signals to electromagnetic signals for transmitting data packets, and electromagnetic signals to electrical signals for receiving data packets. The antenna 122 may comprise plural independent radiator structures, each having a separate radiation pattern for implementing spatial multiplexing. In one embodiment, the wireless network interface implements one or more well-known standards, such as the Institute of Electrical and Electronics Engineers (IEEE) standard 802.11, which defines a system for wireless local area networking. The antenna 122 is configured establish wireless client links 134 to antennas 132 coupled to corresponding client devices 130. The smart network host device 120 implements Ethernet layer 2 switching for wireless data packets forwarded among client devices 130 as well as internet protocol (IP) layer 3 routing between an IP domain associated with the smart network 102 and the external network 110. In this configuration, the smart network host device 120 provides related services and protocols, such as dynamic host configuration protocol (DHCP), network address translation (NAT), and the like.

The smart network host device 120 acts as a central authentication authority for the smart network 102 and implements authentication services for devices registering with the smart network 102. In one embodiment, authentication is implemented via Identification (ID) devices 136 that are uniquely paired with corresponding client devices 130. For example, client device 130(0) may be uniquely paired with ID device 136(0) by a manufacturer of the client device 130(0). An ID device 136(0) is physically presented to the smart network host device 120 as an authentication credential to allow a client device 130(0) paired to the ID device 136(0) to join the smart network 102. Furthermore, the client device 130(0) is able to authenticate the smart network 102 as a trusted network by accessing credentials for the corresponding ID device 136(0) specifically via the smart network 102. In one embodiment, the ID devices 136 are implemented as near field radio frequency identification (RFID) tags. Each one of the RFID tags is configured to retain authentication credentials necessary to uniquely associate the one RFID tag with one instance of the client device 130. In this way, an RFID tag may be paired with a given client device 130. Persons skilled in the art will recognize that any technique may be implemented to generate and represent authentication credentials without departing from the scope and spirit of the present disclosure. In alternative embodiments, other forms of ID devices 136 may implement storage of the authentication credentials. For example, a universal serial bus (USB) storage device may be used to present authentication credentials to the smart network host device 120 for authenticating a related device, such as the computer 170. In other alternative embodiments, a user may manually authenticate a client device 130 with the smart network host device 120. For example, the user may log onto a management web page generated by the smart network host device 120 and manually enter authentication credentials, such as a printed code associated with the client device 130.

In one usage scenario involving ID device 136, the user wishes to add a new device, such as a smart-network-enabled printer to the smart network 102. The printer includes an ID device 136 implemented as an RFID tag that is paired to the printer. The user places the ID device 136 in close physical proximity to the smart network host device 120, which is then able to read the ID device 136 and authenticate the printer. The printer registers with the smart network host device 120 and is then available for use by devices connected within the smart network 102. Upon successfully reading the ID device 136, the smart network host device 120 may indicate success to the user by flashing a light-emitting diode (LED), or by generating any technically feasible indication.

FIG. 1C illustrates the smart network 102, according to another embodiment of the present disclosure. Here, the smart network 102 comprises a smart network host device 120, a smart network extender device 140, one or more client devices 130, and a wide area network (WAN) interface device 112, coupled to the external network 110 of FIG. 1A. The WAN interface device 112, smart network host device 120, and one or more client devices 130 are configured to operate as previously described in FIG. 1B.

In addition to previously described functionality, the smart network host device 120 is also configured to detect one or more smart network extender devices 140 and to establish a bridge link 128 to each of the one or more smart network extender devices 140. Each smart network extender device 140 is configured to act as a network bridge between a client device 130 and the smart network host device 120. For example, client devices 130(1) through 130(N) may be physically located such that they are able to connect to the smart network extender device 140, but not to the smart network host device 120. Furthermore, the smart network extender device 140 is able to connect to the smart network host device 120 via bridge link 128. Data packets transmitted by client devices 130(1) through 130(N) and destined to the external network 110 are received by the smart network extender device 140 and retransmitted by the smart network extender device 140 via bridge link 128 to the smart network host device 120, which then forwards the data packets to the external network 110. Similarly, data packets from the external network 110 that are destined to any of the client devices 130(1) through 130(N) are transmitted via bridge link 128 to the smart network extender device 140, which retransmits the data packets via wireless client links 134(1)-134(N). Persons skilled in the art will understand that wireless client links 134(1)-134(N) may each be configured to operate on a separate channel or band, or a common channel or band. Furthermore, bridge link 128 may operate on a separate channel or band with respect to the wireless client links 134.

In one embodiment, each smart network extender device 140 is paired to an ID device 136, which is presented as an authentication credential to the smart network host device 120 to enable the smart network extender device 140 to participate within the smart network 102.

FIG. 1D illustrates the smart network 102, according to yet another embodiment of the present disclosure. Here, the smart network 102 comprises a smart network host device 120, a smart network extender device 140, one or more client devices 130, a smart network connector device 150, and a wide area network (WAN) interface device 112, coupled to the external network 110 of FIG. 1A. The WAN interface device 112, smart network extender device 140, and one or more client devices 130 are configured to operate as previously described in FIGS. 1B and 1C.

In this embodiment, the smart network host device 120 is configured to operate similarly with respect to FIGS. 1B and 1C. However, upon detecting the smart network connector device 150, the smart network host device 120 is configured to operate as a bridge rather than a router, and the smart network connector device 150 is configured to operate as a router. A backhaul link 158 is established between the smart network host device 120 and the smart network connector device 150.

Network data traffic between client device 130(N) and the external network 110 traverses wireless client link 134(N), bridge link 128, and backhaul link 158. This network data traffic is also forwarded by smart network extender device 140, smart network host device 120, and smart network connector device 150. A client device 130 may connect directly to any one of the smart network extender device 140, smart network host device 120, or smart network connector device 150. As shown, client device 130(0) is connected to smart network connector device 150 via wireless client link 134(0), client device 130(1) is connected to smart network host device 120 via wireless client link 134(1), and client device 130(N) is connected to smart network extender device 140 via wireless client link 134(N).

In one embodiment, the smart network connector device 150 is paired to an ID device 136, which is presented as an authentication credential to the smart network host device 120 to enable the smart network connector device 150 to participate within the smart network 102. In an alternative embodiment, the smart network connector device 150 and the smart network host device 120 are paired during a manufacturing step, eliminating the need for a separate ID device 136.

FIG. 1E is a more detailed illustration of the smart network host device 120, according to one embodiment of the present disclosure. As shown, the smart network host device 120 comprises a processor complex, 160, a wireless network interface 162, an ID device reader 164, and a wired network interface 166. An interconnect 165 is configured to transmit data among the processor complex 160, wireless network interface 162, ID device reader 164, and wired network interface 166. The wired network interface 166 is configured transmit data packets via network interface 118, based on data received via the interconnect 165. The wired network interface 166 is also configured to receive data packets from the network interface 118 and transmit contents of the received data packets to the processor complex 160 via the interconnect 165. The wireless network interface 162 is configured to transmit data packets, based on data received via the interconnect 165, to one or more network devices within range. The wireless network interface 162 is also configured to receive data packets from the one or more network devices and then transmit contents of the received packets to the processor complex 160. The wireless network interface 162 is coupled to an antenna 122.

The processor complex 160 comprises a central processing unit (CPU), non-volatile memory for storing persistent programs, program state, and configuration information, random access memory (RAM) for storing temporary or volatile data, and an interface to the interconnect 165. In one embodiment, the processor complex 160 is configured to execute an operating system and applications that provide routing services. The routing services may include, for example, data packet forwarding between the network interface 118 and the wireless network interface 162. The packet forwarding services may include, without limitation, bridging among the one or more network devices via the wireless network interface 162.

The ID device reader 164 is configured to read data from an associated ID device 136. In one embodiment, the ID device reader 164 is configured to read data from RFID tags comprising the ID device 136. The ID device reader 164 may also include a USB reader.

In certain embodiments, the smart network host device 120 comprises one or more integrated circuits that implement respective functions of the smart network host device 120. For example, the processor complex 160, wired network interface 166, and wireless network interface 162 may be integrated into a single integrated circuit.

Persons skilled in the art will recognize that the smart network extender device 140 may be implemented using the basic architecture of the smart network host device 120, with the exception that the ID device reader 164 and wired network interface 166 are not required for the smart network extender device 140. Similarly, the smart network connector device 150 may be implemented using the basic architecture of the smart network host device 120, with the exception that the ID device reader 164 is not required for the smart network connector device 150.

FIG. 1F illustrates a system software architecture 104 for the smart network host device 120, according to one embodiment of the present disclosure. As shown, the software architecture 104 includes several software modules within the smart network host device 120. Programming instructions stored within the processor complex 160 implement a portion of the system software architecture 104 that includes a runtime server 180, a product solution space 190, and a network solution space 196. The product solution space 190 comprises an object model 192 and one or more solution applications 194. The object model 192 provides a standard, consistent abstraction of different network elements and related services within the smart network 102. Exemplary network elements include devices coupled to the smart network 102, such as printers, cameras, and display devices. Exemplary services include device and service discovery, event tracking and generation, and state presentation for the different elements. In one embodiment, the object model 192 includes a network interface based on the well-known extensible markup language (XML). One or more solution applications 194 provide specific functionality, such as a specific view of a storage system, or a specific technique for presenting certain data. The network solution space 196 includes software modules configured to provide management of network elements and network services, including device services, local area network services within the smart network 102, and wide area network services related to connectivity management of the external network 110.

The runtime server 180 comprises a network provisioning module 182, a service and discovery provisioning (SDP) module 184, an event module 186, and a network configuration module 188. The event module 186 tracks different network events, such as a network device advertising presence or updating status within the smart network 102. The SDP module 184 maintains a persistent view of different network devices and related services, based on data from the event module 186 and on data from the network devices. The network provisioning module 182 provides authentication and authorization for network devices within the smart network 102. Authentication credentials may be presented via a given ID device 136. The network provisioning module 182 may also facilitate certain network services, such as DHCP leases. The network configuration module 188 includes hardware platform-specific implementation methods for network configuration and management. The persistent view comprises the network state model 178 of FIG. 1A.

Persons skilled in the art will recognize that the smart network connector device 150 and smart network extender device 140 may be implemented using an appropriate subset of the system software architecture 104 described above in conjunction with FIG. 1F.

### An Example Physical Tag-Based Subscription

One problem with current smart networks is that users typically manually subscribe to network-delivered services and resources. The subscription methods are often time consuming, may entail the user inputting personal or financial information, and may require the user to have some technical knowledge about the service or resource to activate the subscription, making it difficult for users to access web-based services and resources.

Accordingly, what is needed are techniques and apparatus for automatically subscribing to and enabling such services or resources, especially in a smart network.

Embodiments of the present disclosure employ physical tags to identify web-based services and/or resources. By swiping or placing a service or resource tag in close proximity to a smart network host device, such as a home network router, that service or resource may be added to the network. In other words, when the physical tag is read by the router, the tag may identify the service or resource and, with the router, may automatically subscribe the home network (and hence, the user) to that service or resource.

As used herein, a “resource” generally refers to any physical or virtual component of limited availability. Examples of web-based services or resources may include storage (e.g., additional storage capacity), subscription services, software, or specific events or information. For example, a storage service or resource may allow a smart network to have access to additional storage in the cloud, such as an additional 10 GB. Subscription services may include video or audio services for renting, purchasing, or streaming. The concept of software as an example service or resource may include automatically downloading software applications, upgrades, or features to any of various suitable devices, such as a smart host network device, a computer, and the like. Examples of specific events or information services or resources may include televised sporting events (e.g., a boxing or mixed martial arts bout), audio or video education (e.g., for learning a language, tutoring, or experiencing a how-to series), etc. In particular, the services or resources may be fee-based.

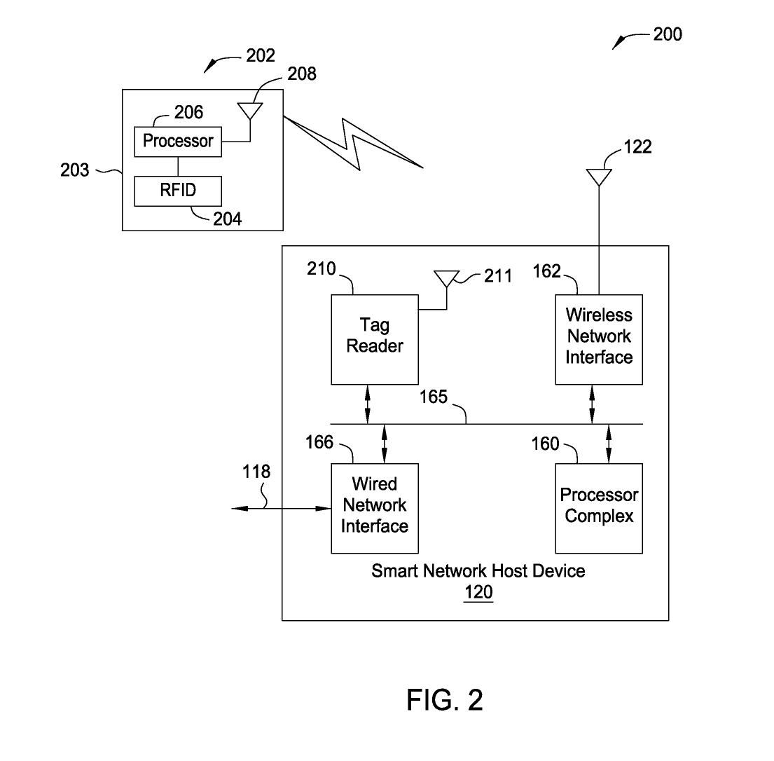

FIG. 2 illustrates an example network 200, such as the smart network 102 of FIG. 1A, for automatically accessing or adding services or resources, according to an embodiment of the present disclosure. As shown, the network 200 may include an electromagnetic tag 202, which may be read by a smart network host device, similar to the smart network host device 120 of FIG. 1E. The electromagnetic tag 202 may use a signal or field at any frequency (or wavelength) in the electromagnetic spectrum to convey information, including electric (e.g., radio frequency (RF)), magnetic, or optical (e.g., infrared) signals.

The smart network host device 120 may be configured to read the electromagnetic tag 202 via any of various suitable techniques. These techniques may include locating the tag 202 within range of a tag reader 210, such as swiping the tag 202 on the tag reader 210 or placing the tag 202 in close proximity to the tag reader 210 such that near field communication (NFC) may be used to wirelessly communicate via magnetic field induction between the tag 202 and the tag reader 210 in a radio frequency identification (RFID) system. Typically operating at about 13.56 MHz, NFC typically uses magnetic induction between two loop antennas (such as antennas 208 and 211) within each other's near field, effectively forming an air-core transformer. The distance between the tag 202 and the tag reader 210 for successful NFC is typically less than about 5 cm. Therefore, as used herein, “close proximity” generally refers to a distance less than about 5 cm. The electromagnetic tag 202 may also utilize a magnetic strip, a bar code such as a Universal Product Code (UPC), or a quick response (QR) code.

The electromagnetic tag 202 may include a housing 203, a storage medium 204 storing an RFID number or other number identifying a web-based service or resource (or any similar readable medium which stores basic information about a web-based service or resource), a processor 206 (e.g., an RFID chip), and an antenna 208. The storage medium 204, processor 206, and antenna 208 may be at least partially disposed within the housing 203, which may comprise a plastic card or other enclosure. The tag 202 may be offered for sale just about anywhere, including in any retail store or online, similar to gift certificates.

For some embodiments, the electromagnetic tag 202 may be a passive tag without a power source. In such embodiments, electromagnetic waves transmitted from the tag reader 210 may be used to energize the processor 206. For other embodiments the electromagnetic tag may include a battery for powering the processor 206 and offering increased transmission power from a transmitter in or associated with the processor 206.

For some embodiments, the electromagnetic tag 202 may store information about the user's usage of certain services or resources for billing purposes. For other embodiments, the electromagnetic tag 202 may act as a debit or credit card, storing a debit or credit limit and tracking usage to maintain a debit or credit balance as a user accesses certain services or resources, tracking an amount of time for each access or charging for each access.

When the electromagnetic tag 202 is swiped or placed near the smart network host device 120, the basic information stored in the storage medium 204 (e.g., the RFID) may be recalled by the processor 206. The information may be transmitted from the electromagnetic tag 202 via the antenna 208 to the antenna 211 on the tag reader 210, where the transmitted signal is read by the tag reader 210 and subsequently processed by the processor complex 160.

When the electromagnetic tag 202 is read by the tag reader 210, the smart network host device 120 may contact the web-based service or resource provider indicated by the information received from the electromagnetic tag 202 and may automatically subscribe to that service or resource. The smart network host device 120 may enable the service or resource by sending the service or resource provider a request message to activate the service or resource. The request message may be based on the information received from the electromagnetic tag 202. In this manner, a service or resource may be automatically subscribed to by the smart network host device 120 without the user being involved or employing any technical knowledge of how the service or resource is enabled or delivered. Further, where the service/resource is fee-based, the payment is facilitated either because the service/resource was paid for when the electromagnetic tag 202 was purchased, or because a payment transaction is initiated automatically at the time the electromagnetic tag 202 is read by the tag reader 210, as in the case where the electromagnetic tag 202 contains credit/debit card information.

As described above, the service may be an audio or video service, and the resource may be online storage in the cloud. Also for some embodiments, the subscription may be to an event, such as a televised sporting event or education broadcast (e.g., Pay-Per-View). Once subscribed to by the smart network host device 120, the service, event, or resource may be accessed by any client device which is associated with the network 200. The client device may be a computer, laptop, tablet, netbook, smart phone, cellular phone, video game console, personal digital assistant (PDA), MP3 player, networked stereo, television, or other user terminal.

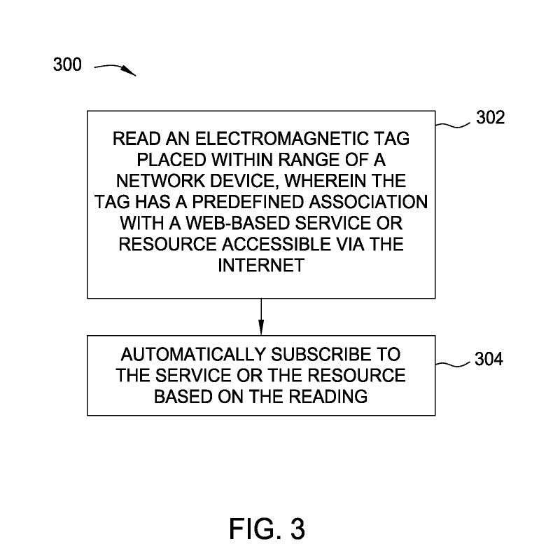

According to some embodiments, the electromagnetic tag 202 may be configured to attach to or associate with a particular client device, allowing the user to access the subscription services, events, or resources from any router configured to read the tag, by placing the particular client device within range of a network host device 120. FIG. 3 is a flow diagram of example operations 300 for automatically subscribing to a service or resource based on reading a physical tag, according to certain embodiments of the present disclosure. The operations 300 may be performed by a network device (e.g., the smart network host device 120 of FIG. 2). The operations 300 may begin, at 302, by reading an electromagnetic tag placed within range of the network device (e.g., swiped at or located in close proximity to the network device). The tag may be read with the tag reader 210 of FIG. 2. The tag may have a predefined association with a web-based service or a resource accessible via the Internet. For example, the tag may have information stored in a storage medium (e.g., a memory) indicating the predefined association with the web-based service or resource. For some embodiments, the tag may be an NFC tag or RFID tag.

For some embodiments, reading the tag at 302 may include reading an indication of the predefined association with the service or the resource. As used herein, an “indication” generally refers to a sign, to anything serving as a sign, symbol, or representation, or to something evident that makes known or identifies the existence or presence of something else (e.g., the predefined association). Examples of an indication include a message (or portion thereof, such as a field in the message) or a number, such as an RFID number.

At 304, the network device may automatically subscribe to the service or the resource based on the reading at 302. For some embodiments, the service or resource comprises storage. For some embodiments, the network device automatically subscribes to the service or resource by subscribing to a web-based audio or video service, program, or event. For some embodiments, the network device automatically enables the service or resource by transmitting a message (e.g., a request message) to a service or resource provider (e.g., an Internet service provider (ISP)) to activate the service or resource for the network device.

As a specific example of the operations 300, a smart host network device (e.g., a home network router) may receive a signal from an NFC tag (or an RFID tag) after the tag is placed within range of the smart network host device. The signal may indicate an identification number (e.g., an RFID number) associated with a web-based service or resource accessible via the Internet. The smart host network device may then automatically subscribe to the service or the resource indicated by the received signal by transmitting a message from the smart network host device to a service or resource provider for activation of the service or the resource for the smart network host device.

While the foregoing is directed to embodiments of the present disclosure, other and further embodiments of the disclosure may be devised without departing from the basic scope, thereof, and the scope thereof is determined by the claims that follow.

What is claimed is:

1. A method comprising:
reading an electromagnetic tag within range of a network device, wherein the tag has a predefined association with a web-based service or resource; and
automatically subscribing to the service or the resource based on the reading.

2. The method of claim 1, wherein the tag comprises a radio frequency identification (RFID) tag or a near field communication (NFC) tag.

3. The method of claim 1, wherein the network device comprises a smart network host device.

4. The method of claim 1, wherein the service or the resource comprises one of:
storage; or
a video or audio service, program, or event.

5. The method of claim 1, wherein automatically subscribing to the service or the resource comprises transmitting a message to a service or resource provider to activate the service or the resource for the network device.

6. The method of claim 1, wherein reading the tag comprises reading an indication of the predefined association with the service or the resource.

7. The method of claim 6, wherein the indication of the predefined association comprises a radio frequency identification (RFID) number.

8. An apparatus comprising:
a reader configured to read an electromagnetic tag within range of the reader, wherein the tag has a predefined association with a web-based service or resource; and
a processor configured to automatically subscribe to the service or the resource based on the reading of the tag.

9. The apparatus of claim 8, wherein the reader is configured to read the tag by receiving an indication of the predefined association with the service or the resource, wherein the indication comprises a radio frequency identification (RFID) number.

10. The apparatus of claim 8, wherein the apparatus comprises a home network router.

11. The apparatus of claim 8, wherein the service or the resource comprises one of:
storage; or
an audio or a video service, program, or event.

12. The apparatus of claim 8, wherein the processor is configured to automatically subscribe to the service or the resource by transmitting a message to a service or resource provider to activate the service or the resource for the apparatus.

13. The apparatus of claim 12, wherein the message comprises an indication of the predefined association with the service or the resource.

14. An apparatus comprising:
a housing;
a storage medium disposed within the housing and configured to store an indication of a predefined association with a web-based service or resource to be automatically subscribed to by a smart host network device; and
an antenna for transmitting the indication of the predefined association with the service or the resource.

15. The apparatus of claim 14, wherein the housing comprises a plastic card.

16. The apparatus of claim 14, wherein the apparatus comprises a radio frequency identification (RFID) tag or a near field communication (NFC) tag.

17. The apparatus of claim 14, wherein the service or the resource comprises one of:
storage; or
an audio or video service, program, or event.

18. The apparatus of claim 14, wherein the indication of the predefined association comprises a radio frequency identification (RFID) number.

19. A method comprising:
receiving, at a smart network host device, a signal from a near field communication (NFC) tag, wherein the signal indicates an identification number associated with a web-based service or resource; and
automatically subscribing to the service or the resource indicated by the received signal by transmitting a message from the smart network host device to a service or resource provider for activation of the service or the resource for the smart network host device.

20. The method of claim 19, wherein the message comprises the identification number.
